(19) United States
(12) Patent Application Publication
(10) Pub. No.: US 2026/0214285 A1
(43) Pub. Date: Jul. 23, 2026

(54) DISTRIBUTION SYSTEM AND SERVER

(71) Applicant: JVCKENWOOD CORPORATION, Yokohama-shi (JP)

(72) Inventors: Tomoyuki UDAGAWA, Yokohama-shi (JP); Ryosuke NAKAGOSHI, Yokohama-shi (JP)

(21) Appl. No.: 19/438,817

(22) Filed: Jan. 2, 2026

Related U.S. Application Data
(63) Continuation of application No. PCT/JP2024/023717, filed on Jul. 1, 2024.

(30) Foreign Application Priority Data
Jul. 3, 2023 (JP) 2023-109420
May 20, 2024 (JP) 2024-081651

(51) Int. Cl. H04N 21/24; H04N 21/218; H04N 21/239; H04N 23/90

(52) U.S. Cl. CPC H04N 21/2408; H04N 21/21805; H04N 21/2393; H04N 23/90

(57) ABSTRACT

A server is configured to: distribute an image to viewer terminals in real time; receive requests of viewers for the image from the viewer terminals; sum up the received requests; generate request information indicating the requests of the viewers based on a result of summing up the received requests; transmit the generated request information to a distributor terminal that is transmitting image data of the image serving as a target of the requests; acquire, from the distributor terminal, acceptance information indicating that a distributor who possesses the distributor terminal has responded to at least one request of the requests of the viewers; record a performance record in which the distributor has responded to the at least one request based on the acquired acceptance information; and determine a reward amount for the distributor based on the recorded performance record.

### CROSS-REFERENCE TO RELATED APPLICATIONS

The present application is a continuation of International Application No. PCT/JP2024/023717, filed on Jul. 1, 2024, and based upon and claims the benefit of priorities from Japanese Patent Application No. 2023-109420 filed on Jul. 3, 2023 and Japanese Patent Application No. 2024-081651 filed on May 20, 2024, the entire contents of which are incorporated herein by reference.

### BACKGROUND

JP 2014-064241 A describes a location publication system in which an owner of each of a plurality of surveillance cameras accesses a server from a setting terminal, and can change a setting of whether an image of the owner's own surveillance camera is open or closed to the public as appropriate by the owner's own will.

The location publication system of JP 2014-064241 A includes a viewing user terminal that allows a user to access a location publication server via a network and request image information of a desired place. In a case where there is a request for image information of a desired place from a viewing user, the location publication server specifies a surveillance camera installed at the desired place for the viewing user or installed near the desired place, and transmits the image information of the surveillance camera to the viewing user terminal in a case where the surveillance camera is open to the public.

### SUMMARY

In the location publication system of JP 2014-064241 A, the location publication server includes a billing means that adds up a royalty to the owner of the surveillance camera according to a performance record of information provision to the viewing user. However, the location publication system of JP 2014-064241 A does not have a means to notify the owner of the surveillance camera of the request of the viewing user. Therefore, the owner of the surveillance camera cannot obtain more royalties by grasping the request of the viewing user and responding to the request.

A distribution system in accordance with some embodiments includes a distributor terminal, a plurality of viewer terminals, and a server. The distributor terminal includes an image capturer and is configured to transmit image data of an image captured by the image capturer. The plurality of viewer terminals are configured to transmit requests of a plurality of viewers for the image, respectively. The server is configured to: distribute the image to the plurality of viewer terminals in real time; receive the requests of the plurality of viewers for the image from the plurality of viewer terminals; sum up the received requests; generate request information indicating the requests of the plurality of viewers based on a result of summing up the received requests; transmit the generated request information to the distributor terminal that is transmitting the image data of the image serving as a target of the requests; acquire, from the distributor terminal, acceptance information indicating that a distributor who possesses the distributor terminal has responded to at least one request of the requests of the plurality of viewers; record a performance record in which the distributor has responded to the at least one request based on the acquired acceptance information; and determine a reward amount for the distributor based on the recorded performance record.

A server in accordance with some embodiments includes a processor and a memory including a command that causes the processor to perform processing when executed by the processor. The processing includes: distributing an image captured by a distributor terminal to a plurality of viewer terminals via a network in real time; receiving requests of a plurality of viewers of the plurality of viewer terminals for the image from the plurality of viewer terminals; summing up the received requests; generating request information indicating the requests of the plurality of viewers based on a result of summing up the received requests; transmitting the generated request information to the distributor terminal that is transmitting image data of the image serving as a target of the requests; acquiring, from the distributor terminal, acceptance information indicating that a distributor who possesses the distributor terminal has responded to at least one request of the requests of the plurality of viewers; recording a performance record in which the distributor has responded to the at least one request based on the acquired acceptance information; and determining a reward amount for the distributor based on the recorded performance record.

A multi-angle distribution system in accordance with some embodiments distributes, in real time, images based on a plurality of pieces of image data obtained by capturing the same scene from a plurality of different viewpoints from each other. The multi-angle distribution system includes a plurality of distributor terminals that each include an image capturer and transmit image data captured by the image capturer, a viewer terminal that transmits requests of viewers for a first image captured from a specific viewpoint out of the plurality of viewpoints, and a server that distributes the first image in real time, receives the requests of the viewers for the first image, sums up the requests of the viewers, generates request information, which is representative information indicating the requests of the viewers on a basis of a result of summing up the requests of the viewers, and transmits the request information generated to a first distributor terminal that is transmitting first image data of the first image. The server acquires, from the first distributor terminal, acceptance information indicating that a first distributor who possesses the first distributor terminal has responded to the request of the viewer, records a performance record in which the first distributor has responded to the request of the viewer on a basis of the acceptance information acquired, and determines a reward amount for the first distributor on a basis of the performance record.

A server in accordance with some embodiments distributes, in real time, images based on a plurality of pieces of image data obtained by capturing the same scene from a plurality of different viewpoints from each other. The server includes a distributor that distributes the image data via a network, a summing unit that sums up requests of viewers for a first image captured from a specific viewpoint out of the plurality of viewpoints, a transmitter that generates request information, which is representative information indicating the requests of the viewers on a basis of a result of summing up the requests of the viewers and transmits the request information generated to a first distributor terminal that is transmitting first image data of the first image, a recorder that acquires, from the first distributor terminal, acceptance information indicating that a first distributor who possesses the first distributor terminal has responded to the request of the viewer and records a performance record in which the first distributor has responded to the request of the viewer, and a determiner that determines a reward amount for the first distributor on a basis of the performance record.

### BRIEF DESCRIPTION OF DRAWINGS

FIG. 1 is a block diagram illustrating an overall configuration example of a multi-angle distribution system according to an embodiment.

FIG. 2 is a block diagram illustrating a configuration example of a distributor terminal included in the multi-angle distribution system according to the embodiment.

FIG. 3 is a block diagram illustrating a configuration example of a viewer terminal included in the multi-angle distribution system according to the embodiment.

FIG. 4 is a block diagram illustrating a configuration example of a server included in the multi-angle distribution system according to the embodiment.

FIG. 5 is a diagram for explaining respective functions of the server, the distributor terminal, and the viewer terminal included in the multi-angle distribution system according to the embodiment.

FIG. 6 is a diagram illustrating a display example of a movement request direction displayed on an operation display of the distributor terminal.

### DETAILED DESCRIPTION

Hereinbelow, a multi-angle distribution system (distribution system) 1 according to an embodiment will be described with reference to the accompanying drawings. In the description of the drawings, the same elements are labeled with the same reference numerals, and description thereof is omitted.

### Overall Configuration Example of Multi-Angle Distribution System

The multi-angle distribution system 1 according to the present embodiment is a system that distributes, in real time, images based on a plurality of pieces of image data obtained by capturing the same scene from a plurality of different viewpoints from each other in a place such as a live show venue. For example, the multi-angle distribution system 1 distributes, in real time, images from a plurality of different viewpoints captured by distributor terminals 20 respectively possessed by a plurality of distributors who are in the same live show venue. As a result, the multi-angle distribution system 1 provides a service that allows a plurality of viewers located in remote places to view an image freely selected from among the images from the plurality of viewpoints using viewer terminals 30 respectively possessed by the viewers.

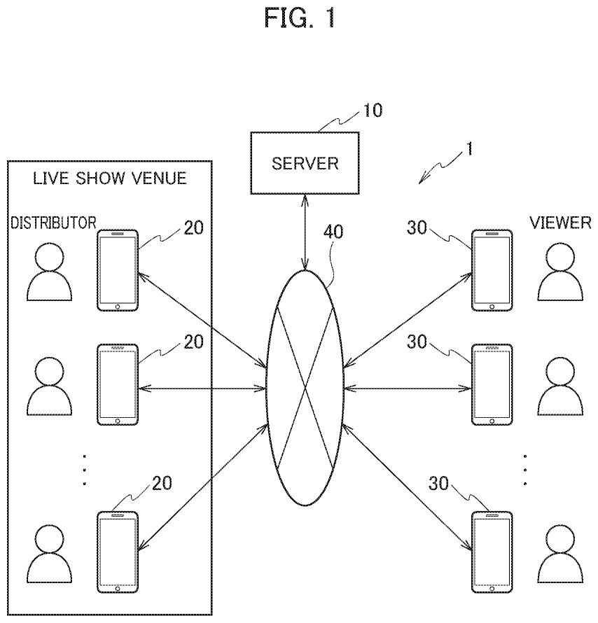

As illustrated in FIG. 1, the multi-angle distribution system 1 includes a server 10, the plurality of distributor terminals 20, the viewer terminals 30, and a communication network (hereinafter, simply referred to as a network) 40. The network 40 is, for example, the Internet. The network 40 may use a mobile communication function such as 4G/LTE or 5G. Note that the number of the distributor terminals 20 and the number of the viewer terminals 30 are not limited to particular ones. In a case where there is one distributor terminal 20, the multi-angle distribution system 1 may be simply referred to as a distribution system 1.

### Configuration Example of Distributor Terminal

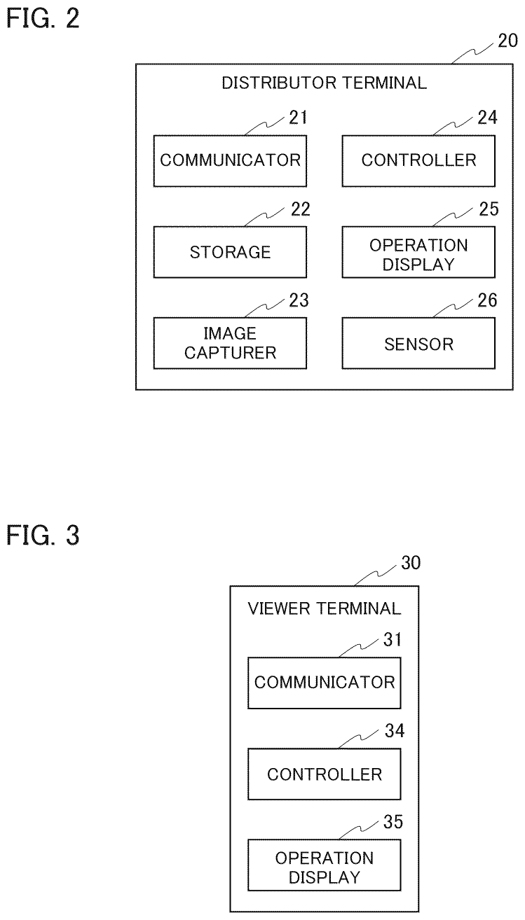

A configuration example of the distributor terminal 20 will be described with reference to FIG. 2. The distributor terminal 20 is a computer used by a distributor. The distributor terminal 20 is, for example, a portable terminal such as a smartphone, a tablet terminal, or a wearable terminal (for example, a head-mounted display or a smart glass). The distributor terminal 20 includes a communicator 21, a storage 22, an image capturer 23, a controller 24, an operation display 25, and a sensor 26. The distributor terminal 20 has a function of transmitting image data of an image captured by the image capturer 23 to the server 10 in real time via the network 40.

The communicator 21 is implemented as hardware such as a network adapter, various types of communication software, and a combination thereof, and is achieved by a communication device configured to be able to perform wireless or wired communication via the network 40 or the like. The communicator 21 has functions as an input and an output for transmitting and receiving data. Note that the communicator 21 may be, for example, a device having a mobile communication function such as 4G/LTE or a device having a Wi-Fi (registered trademark) communication function.

The communicator 21 communicates with the server 10 via the network 40. The communicator 21 receives predetermined data from the server 10 and transmits predetermined data to the server 10.

The storage 22 is achieved by, for example, a semiconductor memory element such as a random access memory (RAM) or a flash memory, or a storage device such as a hard disk or an optical disk. The storage 22 stores image data of an image captured by the image capturer 23.

The image capturer 23 includes an imaging element such as a complementary metal oxide semiconductor (CMOS) or a charge-coupled device (CCD).

The operation display 25 displays information necessary for operation of a distributor who possesses the distributor terminal 20, and receives an input operation from the distributor who possesses the distributor terminal 20. For example, as the operation display 25, a touch panel with which an input operation can be performed according to information displayed on the display can be used. Note that the operation display 25 may be configured such that an operation unit that receives the input operation from the distributor and a display that displays information necessary for the operation of the distributor are separated. The operation display 25 is connected to the controller 24, and information received by the operation display 25 is transmitted to the controller 24.

The sensor 26 is, for example, any of various sensors such as a global positioning system (GPS) sensor, an acceleration sensor, and a gyro sensor. The sensor 26 is connected to the controller 24, and information such as position information, acceleration information, and angular velocity information detected by the sensor 26 is transmitted to the controller 24.

The controller 24 is a microcomputer mainly including a central processing unit (CPU), a memory, and an input/output interface. A predetermined computer program is installed in the controller 24. The controller 24 achieves various functions of the distributor terminal 20 by executing the computer program.

The controller 24 transmits image data stored in the storage 22 to the server 10 in real time via the network 40. Note that the controller 24 may directly acquire the image data of the image captured by the image capturer 23 from the image capturer 23 and transmit the image data to the server 10 in real time via the network 40.

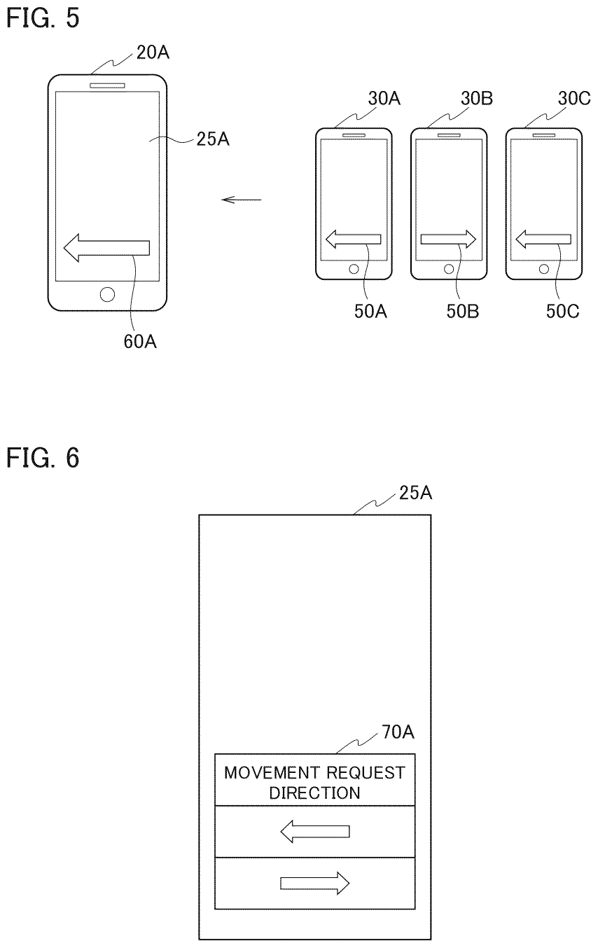

The controller 24 displays, on the operation display 25, request information, which is representative information indicating a request of the viewer to the distributor terminal 20 received from the server 10 to be described below. The controller 24 transmits, to the server 10 via the network 40, acceptance information, which is information indicating that the distributor who possesses the distributor terminal 20 to be described below has responded to the request of the viewer received from the server 10. Specific examples of the request information and the acceptance information will be described below with reference to FIGS. 5 and 6.

### Configuration Example of Viewer Terminal

A configuration example of the viewer terminal 30 will be described with reference to FIG. 3. The viewer terminal 30 is a computer used by a viewer. The viewer terminal 30 is, for example, a terminal device such as a smartphone, a tablet terminal, a wearable terminal (for example, a head-mounted display or a smart glass), or a laptop personal computer. The viewer terminal 30 includes a communicator 31, a controller 32, and an operation display 33. The viewer terminal 30 has a function of transmitting, to the server 10, a request of the viewer who possesses the viewer terminal 30 for a certain first image captured from a specific viewpoint and viewed by the viewer.

The communicator 31 has a similar configuration to that of the communicator 21, and communicates with the server 10 via the network 40. The communicator 31 receives predetermined data from the server 10 and transmits predetermined data to the server 10.

The operation display 33 displays image data acquired from the server 10, and receives an input operation from the viewer who possesses the viewer terminal 30. For example, as the operation display 33, a touch panel with which the viewer can perform an input operation can be used. Note that the operation display 33 may be configured such that an operation unit that receives the input operation from the viewer and a display that displays the first image are separated. The operation display 33 is connected to the controller 32, and information received by the operation display 33 is transmitted to the controller 32.

The controller 32 is a microcomputer mainly including a CPU, a memory, and an input/output interface. A predetermined computer program is installed in the controller 32. The controller 32 achieves various functions of the viewer terminal 30 by executing the computer program.

The controller 32 acquires, in real time via the network 40, each piece of image data of a plurality of images which are obtained by capturing the same scene from a plurality of different viewpoints from each other and which are distributed from the server 10. The controller 32 displays the image data acquired from the server 10 on the operation display 33. The controller 32 displays, on the operation display 33, image data of an image selected by the viewer via the operation display 33 from among the pieces of image data of the plurality of images obtained by capturing the same scene from the plurality of different viewpoints from each other. The controller 32 may acquire the image data selected by the viewer from among the plurality of pieces of image data distributed from the server 10 and display the image data on the operation display 33.

In a case where the operation display 33 accepts a request of the viewer for the first image being viewed by the viewer, the controller 32 transmits information indicating the request of the viewer to the server 10 via the network 40. A specific example of the information indicating the request of the viewer will be described below with reference to FIG. 5.

### Configuration Example of Server

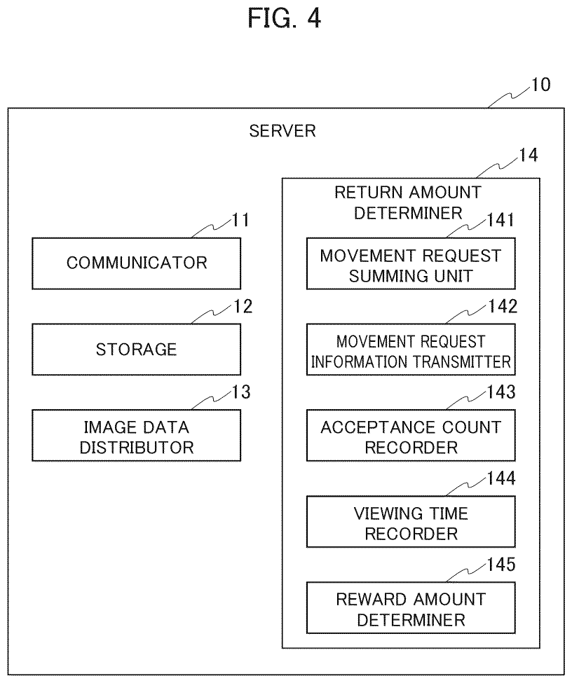

A configuration example of the server 10 will be described with reference to FIG. 4. The server 10 is configured to be able to communicate with each of the plurality of distributor terminals 20 and the viewer terminals 30 via the network 40. In the description of the present embodiment, the operation of the server 10 in a case where a first distributor terminal 20A among the plurality of distributor terminals 20 transmits first image data of the first image to the plurality of viewer terminals 30 will be described as an example.

The server 10 includes a communicator 11, a storage 12, an image data distributor (distributor) 13, and a return amount determiner 14. In the present embodiment, the image data distributor 13 and the return amount determiner 14 are included in the same server 10, but the image data distributor 13 and the return amount determiner 14 may be configured as independent servers. Furthermore, the image data distributor 13 and the return amount determiner 14 may be integrally configured.

The communicator 11 has a similar configuration to those of the communicators 21 and 31, and communicates with the distributor terminals 20 and the viewer terminals 30 via the network 40. The communicator 11 receives predetermined data from the distributor terminals 20 and the viewer terminals 30, and transmits predetermined data to the distributor terminals 20 and the viewer terminals 30.

The storage 12 is achieved by, for example, a semiconductor memory element such as a RAM or a flash memory, or a storage device such as a hard disk or an optical disk. The storage 12 stores the image data obtained by capturing the same scene from the plurality of different viewpoints from each other, which is received by the communicator 11 from each distributor terminal 20 via the network 40, in association with an identification (ID), which is information for identifying each distributor terminal 20.

The image data distributor 13 is, for example, a microcomputer mainly including a CPU, a memory, and an input/output interface. The CPU reads various computer programs stored in a memory or the like, and executes various commands included in the programs. By executing the program, the CPU functions as the image data distributor 13. The image data distributor 13 distributes each piece of image data stored in the storage 12 to the viewer terminal 30 in real time via the network 40. Since a specific configuration of the image data distributor 13 is similar to that of a known multi-angle distribution system, the description thereof is omitted here.

The return amount determiner 14 is a microcomputer mainly including a CPU, a memory, and an input/output interface. The CPU reads various computer programs stored in a memory or the like, and executes various commands included in the programs. By executing the program, the CPU functions as a plurality of information processing circuits included in the return amount determiner 14. The return amount determiner 14 includes, as a plurality of information processing circuits, a movement request summing unit (summing unit) 141, a movement request information transmitter (transmitter) 142, an acceptance count recorder (recorder) 143, a viewing time recorder 144, and a reward amount determiner (determiner) 145. Note that, in a case where the image data distributor 13 and the return amount determiner 14 are integrally configured, one CPU may function as the image data distributor 13 and the return amount determiner 14 by executing corresponding programs.

The movement request summing unit 141 receives, via the network 40, requests of the respective viewers transmitted from the viewer terminals 30 for the first image captured from a specific viewpoint, and sums up the received requests of the respective viewers. The movement request information transmitter 142 generates request information, which is representative information indicating the requests of the respective viewers on the basis of the result of summing up the requests of the viewers, and transmits the generated request information to the first distributor terminal 20A transmitting the first image data of the first image.

For example, in FIG. 5, it is assumed that there are first to third viewer terminals 30A to 30C viewing the first image captured from the specific viewpoint by the first distributor terminal 20A. In FIG. 5, a first viewer who possesses the first viewer terminal 30A inputs, for example, as a request for the first image, a first movement request direction 50A (left direction), which is a direction in which the first viewer wishes to move the viewpoint with respect to the first image, via the operation display of the first viewer terminal 30A. The first viewer inputs the first movement request direction 50A by an operation such as swiping. Note that the “direction in which the first viewer wishes to move the viewpoint” mentioned here may mean a direction in which the viewer wishes to move the angle with respect to the image capturing target captured by the first distributor terminal 20A, or may mean a direction in which the viewer wishes to move the direction (image capturing target) itself captured by the first distributor terminal 20A. The request of the viewer may include not only a request for movement of the viewpoint but also a request for zooming (in or out) of the viewpoint. For example, a movement request amount, which is an amount by which the viewer wishes to move the viewpoint, may be calculated according to the length of the trajectory of the swiping operation, and the movement request amount may be included in the request of the viewer.

A second viewer who possesses the second viewer terminal 30B inputs a second movement request direction 50B (right direction), which is a direction in which the second viewer wishes to move the viewpoint with respect to the first image, via the operation display of the second viewer terminal 30B. A third viewer who possesses the third viewer terminal 30C inputs a third movement request direction 50C (left direction), which is a direction in which the third viewer wishes to move the viewpoint with respect to the first image, via the operation display of the third viewer terminal 30C. The controller 32 of each of the first to third viewer terminals 30A to 30C transmits each of the first to third movement request directions 50A to 50C to the server 10 via the network 40.

At this time, the movement request summing unit 141 of the server 10 receives the movement request directions 50A to 50C of the viewers with respect to the first image from the first to third viewer terminals 30A to 30C via the network 40. Then, the movement request summing unit 141 sums up the received movement request directions 50A to 50C of the viewers with respect to the first image.

The movement request information transmitter 142 generates request information indicating a movement request direction 60A (left direction) requested the most on the basis of the result of summing up the movement request directions 50A to 50C, and transmits the generated request information to the first distributor terminal 20A via the network 40. The first distributor terminal 20A receives the request information indicating the movement request direction 60A from the movement request information transmitter 142 of the server 10 via the network 40. For example, as illustrated in FIG. 5, the controller 24 of the first distributor terminal 20A displays an arrow indicating the movement request direction 60A received from the movement request information transmitter 142 on an operation display 25A of the first distributor terminal 20A.

In a case where the movement request amounts, each of which is an amount by which the viewer wishes to move the viewpoint, as well as the movement request directions 50A to 50C, are included in the requests of the respective viewers received from the viewer terminals 30A to 30C, the movement request summing unit 141 of the server 10 may calculate a representative value (such as an average value) of the movement request amounts received from the viewer terminals that request the same direction as the movement request direction included in the request information. At this time, the movement request information transmitter 142 may include the representative value calculated by the movement request summing unit 141 in the request information. At this time, the controller 24 of the first distributor terminal 20A may set the length of the arrow indicating the movement request direction 60A to be displayed on the operation display 25A to a length according to the representative value of the movement request amount in the request information, or may display the movement request amount in characters (small, large, or the like).

For example, the movement request information transmitter 142 may generate information in which the movement request directions 50A to 50C are listed in ascending order or descending order according to the number of requests on the basis of the result of summing up the movement request directions 50A to 50C, and transmit the information to the first distributor terminal 20A as the request information. For example, as illustrated in FIG. 6, the first distributor terminal 20A may display a list 70A in which the movement request directions 50A to 50C received from the movement request information transmitter 142 are listed in ascending order according to the number of requests on the operation display 25A of the first distributor terminal 20A. In this manner, the display form of the movement request direction is not limited to a particular one.

The controller 24 of the first distributor terminal 20A displays an arrow indicating the movement request direction 60A on the operation display 25A, and then accepts, via the operation display 25A, that the first distributor who possesses the first distributor terminal 20A has responded to the request of the viewer. For example, in FIG. 5 or 6, in a case where the first distributor touches the arrow indicating the movement request direction 60A displayed on the operation display 25A, the controller 24 accepts that the first distributor has responded to the request of the viewer. The first distributor terminal 20A is only required to be configured such that the first distributor can select to respond to the request of the viewer, and a method of accepting that the first distributor has responded to the request of the viewer is not limited to a particular one. The controller 24 of the first distributor terminal 20A transmits acceptance information indicating that the first distributor has responded to the request of the viewer to the server 10 via the network 40. At this time, the controller 24 of the first distributor terminal 20A may transmit the acceptance information indicating that the first distributor has responded to the request of the viewer together with the identification for identifying the distributor terminal.

Note that, in FIG. 5, the controller 24 of the first distributor terminal 20A may determine whether or not the viewpoint of the first image captured by the first distributor terminal 20A has moved in the movement request direction 60A on the basis of the position information, the acceleration information, the angular velocity information, and the like of the first distributor terminal 20A acquired from the sensor of the first distributor terminal 20A. In addition, the controller of the first distributor terminal 20A may perform image processing on the image data of the first image captured by the first distributor terminal 20A to determine whether or not the viewpoint of the first image captured by the first distributor terminal 20A has moved in the movement request direction 60A. In these cases, the controller 24 of the first distributor terminal 20A transmits the acceptance information to the server 10 in a case of determining that the viewpoint of the first image has moved in the movement request direction 60A.

The acceptance count recorder 143 of the server 10 acquires, from the first distributor terminal 20A, the acceptance information indicating that the first distributor who possesses the first distributor terminal 20A has responded to the request of the viewer. On the basis of the acquired acceptance information, the acceptance count recorder 143 records a performance record in which the first distributor has responded to the request of the viewer together with the identification. With this identification, the first distributor, the first distributor terminal 20A, and the performance record are associated with each other. For example, the acceptance count recorder 143 may record the number of times the first distributor has responded to the request of the viewer as a performance record in which the first distributor has responded to the request of the viewer, or may record a percentage or frequency at which the first distributor has responded to the request of the viewer as a performance record in which the first distributor has responded to the request of the viewer.

The viewing time recorder 144 records cumulative viewing time for which the first image is viewed. Here, the cumulative viewing time means cumulative time for which the first image is viewed by the viewer terminals 30 in the multi-angle distribution system 1. For example, in FIG. 5, the cumulative viewing time is a total value of cumulative time for which the first image is viewed by the first to third viewer terminals 30A to 30C. That is, for example, in a case where the first image is viewed for 0.5 hours in a cumulative manner on the first viewer terminal 30A, for 1.0 hours in a cumulative manner on the second viewer terminal 30B, and for 1.5 hours in a cumulative manner on the third viewer terminal 30C, the cumulative viewing time of the first image is 0.5+1.0+1.5=3 hours.

The reward amount determiner 145 determines a reward amount for the first distributor on the basis of the performance record in which the first distributor has responded to the request of the viewer. Specifically, the reward amount determiner 145 records the performance record in which the first distributor has responded to the request of the viewer on the basis of the acceptance information indicating that the first distributor has moved the angle with respect to the image capturing target captured by the first distributor terminal 20A or the direction in which the first distributor terminal 20A captures the image according to the movement request direction 60A transmitted from the movement request information transmitter 142, and determines the reward amount for the first distributor on the basis of the performance record. Note that the reward amount determiner 145 may determine the reward amount for the first distributor on the basis of the performance record in which the first distributor has responded to the request of the viewer and the cumulative viewing time for which the first image captured by the first distributor is viewed. The reward amount determiner 145 determines the reward amount for the first distributor such that the reward amount for the first distributor is larger as the number of times the first distributor has responded to the request of the viewer is larger and as the cumulative viewing time of the first image is longer.

### Operation and Effect

As described above, the multi-angle distribution system 1 includes the distributor terminal 20, the viewer terminal 30, and the server 10. The distributor terminal 20 includes the image capturer 23 and transmits image data of an image captured by the image capturer 23. The viewer terminal 30 transmits a request of the viewer for a first image captured from a specific viewpoint among a plurality of viewpoints. The server 10 distributes the first image in real time, receives the requests of the viewers for the first image, generates request information that is representative information indicating the requests of the viewers on the basis of a result of summing up the requests of the viewers, and transmits the request information generated to the first distributor terminal 20A that is transmitting first image data of the first image. The server 10 acquires, from the first distributor terminal 20A, acceptance information indicating that the first distributor who possesses the first distributor terminal 20A has responded to the request of the viewer, and records a performance record in which the first distributor has responded to the request of the viewer on the basis of the acceptance information acquired. The server 10 determines a reward amount for the first distributor on the basis of the performance record.

The multi-angle distribution system 1 distributes, in real time, each piece of image data of a plurality of images which are obtained by the plurality of distributor terminals 20 capturing the same scene from a plurality of different viewpoints from each other. The server 10 receives from the viewer terminal 30 a request of a viewer for a first image captured from a specific viewpoint, and transmits information indicating the received request of the viewer to the first distributor terminal 20A that is transmitting first image data of the first image. The first distributor terminal 20A displays the received request of the viewer, so that the first distributor can grasp the request of the viewer for the first image that the first distributor terminal 20A is capturing. When the time and the number of times for the viewer's viewing the first image of the first distributor increase as the first distributor responds to the request of the viewer, the server 10 increases a reward amount for the first distributor. As a result, the multi-angle distribution system 1 can grasp the request of the viewer and return more profit to the distributor who has responded to the request of the viewer.

The server 10 of the multi-angle distribution system 1 records cumulative viewing time for which the first image is viewed, and determines the reward amount for the first distributor on the basis of a performance record in which the first distributor has responded to the request of the viewer and the cumulative viewing time.

As a result, the server 10 can determine the reward amount for the distributor so that the reward amount for the distributor who has responded to the requests of more viewers and has longer cumulative viewing time is larger.

The viewer terminals 30A to 30C of the multi-angle distribution system 1 may transmit, to the server 10, information indicating the movement request directions 50A to 50C, each of which is a direction in which the viewers wish to move the viewpoint with respect to the first image. In this case, the server 10 transmits, to the first distributor terminal 20A, information indicating the movement request direction 60A of the viewers generated on the basis of the result of summing up the received movement request directions 50A to 50C as request information.

The first distributor terminal 20A displays the received information indicating the movement request direction 60A of the viewers, so that the first distributor can grasp the movement request direction 60A of the viewers with respect to the first image that the first distributor is capturing using the first distributor terminal 20A. When the time and the number of times for the viewer's viewing the first image of the first distributor increase as the first distributor changes the viewpoint from which the first distributor terminal 20A captures according to the movement request direction 60A, the server 10 increases a reward amount for the first distributor. As a result, the multi-angle distribution system 1 can grasp the request of the viewer and return more profit to the distributor who has responded to the request of the viewer.

As described above, the embodiment of the present invention has been described, but it should not be understood that the description and drawings constituting a part of this disclosure limit the present invention. Various alternative embodiments, examples, and operation techniques will be apparent to those skilled in the art from this disclosure.

For example, the movement request information transmitter 142 of the server 10 according to the above embodiment transmits request information, which is representative information indicating the requests of the respective viewers for the first image, on the basis of the result of summing up the requests of the viewers to the first distributor terminal 20A transmitting the first image data of the first image. However, the movement request information transmitter 142 may specify a second distributor terminal (not illustrated) transmitting second image data of a second image located near the first distributor terminal 20A, and transmit the request information for the first image to the first distributor terminal 20A and the second distributor terminal. In this case, the movement request information transmitter 142 may specify the second distributor terminal located near the first distributor terminal 20A on the basis of, for example, information such as position information, acceleration information, angular velocity information, and capturing direction information of each distributor terminal detected by the sensor 26 of each distributor terminal. In addition, the movement request information transmitter 142 may specify the second distributor terminal located near the first distributor terminal 20A and capturing the same scene from a similar viewpoint to that of the first distributor terminal 20A by performing image processing on the captured data of the image captured by each distributor terminal.

Note that, in a case where the information indicating the movement request direction with respect to the first image is transmitted to the second distributor terminal as well, the movement request direction to be transmitted to the second distributor terminal may be corrected such that the angle of view in the direction of the viewpoint when the viewpoint of the first image captured by the first distributor terminal 20A moves in the movement request direction and the angle of view in the direction of the viewpoint when the viewpoint of the second image captured by the second distributor terminal moves in the movement request direction substantially coincide with each other, in consideration of the differences in positions and viewpoints between the first distributor terminal 20A and the second distributor terminal.

By transmitting the information indicating the request of the viewer for the first image not only to the first distributor terminal 20A but also to the second distributor terminal located near the first distributor terminal 20A, the distributor can grasp the request of the viewer for the image captured by the distributor terminal 20 possessed by another person. The number of options for the distributor to respond to the request of the viewer increases, and the possibility that the image data of the image meeting the request of the viewer is distributed increases. As a result, it is possible to promote improvement in the degree of satisfaction of the viewer of the multi-angle distribution system 1.

A distribution system 1 according to another embodiment distributes image data of an image captured by one distributor terminal 20 in real time, receives requests of viewers for the image captured by the distributor terminal 20 from viewer terminals 30, and transmits request information, which is representative information indicating the received requests of the viewers, to the distributor terminal 20. In this case, it is possible to notify the distributor of the camera angle that the viewers wish by displaying, on the distributor terminal 20, a movement request direction, which is a result of summing up the requests from the viewers. For example, in a case where the distributor terminal 20 is a professional-use camera, the movement request direction is displayed on the display unit of the professional-use camera, so that the distributor can acquire the camera angle that the viewers wish.

In a case where the profit is returned to the distributor, an application for transmitting the result of evaluating the distributor may be prepared on the viewer terminal 30, and the amount to be returned may be determined on the basis of the result of summing up the evaluation received by the server 10. For example, when the movement request direction transmitted by the viewer is approved, the application may receive a “Like!” comment indicating that the viewer is satisfied, and the number of “Like!” comments summed up by the server 10 may be used as the index of the evaluation. As a result, the distributor appropriately reflects the request of the viewer for the capturing direction, and improvement in the viewer's satisfaction with the distribution system can be promoted.

In the distribution system 1 according to still another embodiment, there is one viewer terminal 30. In this case, the movement request summing unit 141 receives, via the network 40, a request of a viewer transmitted from one viewer terminal 30 for a first image captured from a specific viewpoint. The movement request information transmitter 142 generates request information, which is information indicating the request of the viewer on the basis of the received request of the viewer, and transmits the generated request information to the first distributor terminal 20A transmitting first image data of the first image. In such a configuration as well as the above embodiment, it is possible to grasp the request of the viewer and return more profit to the distributor who has responded to the request of the viewer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A distribution system comprising:
a distributor terminal including an image capturer and configured to transmit image data of an image captured by the image capturer;
a plurality of viewer terminals configured to transmit requests of a plurality of viewers for the image, respectively; and
a server,
wherein the server is configured to:
distribute the image to the plurality of viewer terminals in real time;
receive the requests of the plurality of viewers for the image from the plurality of viewer terminals;
sum up the received requests;
generate request information indicating the requests of the plurality of viewers based on a result of summing up the received requests;
transmit the generated request information to the distributor terminal that is transmitting the image data of the image serving as a target of the requests;
acquire, from the distributor terminal, acceptance information indicating that a distributor who possesses the distributor terminal has responded to at least one request of the requests of the plurality of viewers;
record a performance record in which the distributor has responded to the at least one request based on the acquired acceptance information; and
determine a reward amount for the distributor based on the recorded performance record.

2. The distribution system according to claim 1, wherein
the distributor terminal includes a first distributor terminal configured to transmit first image data of a first image captured from a first viewpoint and a second distributor terminal configured to transmit second image data of a second image captured from a second viewpoint different from the first viewpoint, and
the server is configured to:
distribute the first image and the second image to the plurality of viewer terminals in real time;
receive the requests of the plurality of viewers for the first image from the plurality of viewer terminals; and
transmit the request information indicating the requests of the plurality of viewers for the first image to the first distributor terminal.

3. The distribution system according to claim 2, wherein the server is configured to:
specify the second distributor terminal located near the first distributor terminal, and
transmit the request information indicating the requests of the plurality of viewers for the first image to the first distributor terminal and the second distributor terminal.

4. The distribution system according to claim 1, wherein
each of the plurality of viewer terminals is configured to transmit, to the server, information indicating a movement request direction, which is a direction in which each of the plurality of viewers wishes to move a viewpoint with respect to the image, and
the server is configured to transmit, to the distributor terminal as the request information, information indicating the movement request direction generated based on a result of summing up the received movement request directions.

5. A server comprising:
a processor; and
a memory including a command that causes the processor to perform processing when executed by the processor,
wherein the processing includes:
distributing an image captured by a distributor terminal to a plurality of viewer terminals via a network in real time;
receiving requests of a plurality of viewers of the plurality of viewer terminals for the image from the plurality of viewer terminals;
summing up the received requests;
generating request information indicating the requests of the plurality of viewers based on a result of summing up the received requests;
transmitting the generated request information to the distributor terminal that is transmitting image data of the image serving as a target of the requests;
acquiring, from the distributor terminal, acceptance information indicating that a distributor who possesses the distributor terminal has responded to at least one request of the requests of the plurality of viewers;
recording a performance record in which the distributor has responded to the at least one request based on the acquired acceptance information; and
determining a reward amount for the distributor based on the recorded performance record.
